(19) United States
(12) Patent Application Publication
(10) Pub. No.: US 2016/0201822 A1
(43) Pub. Date: Jul. 14, 2016

(54) SOLENOID VALVE

(71) Applicant: HITACHI AUTOMOTIVE SYSTEMS, LTD., Hitachinaka-shi, Ibaraki (JP)

(72) Inventor: Yasuhide TAKADA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 14/916,213

(22) PCT Filed: Jul. 29, 2014
(86) PCT No.: PCT/JP2014/069879

§ 371 Date: Mar. 3, 2016

(30) Foreign Application Priority Data
Sep. 10, 2013 (JP) 2013-186839

(51) Int. Cl. F16K 31/06; F16K 15/14; F01L 1/34; F16K 15/16

(52) U.S. Cl. CPC F16K 31/0613; F16K 15/16; F16K 15/144; F01L 1/34

(57) ABSTRACT

A solenoid valve is equipped with a check valve and a filter member, which is configured to suppress entry of foreign matter contained in working fluid by means of a filter provided at an opening having an outer periphery surrounded by a frame. The check valve is arranged downstream of the filter member with respect to a free flow direction of the working fluid. A part of the check valve is structured integrally with the frame, and the check valve is configured to open and close by movement of the outer peripheral surface of the check valve out of and into abutted-engagement with the inner peripheral surface of the frame, thereby restricting back-flow of the working fluid.

### TECHNICAL FIELD

The present invention relates to a solenoid valve, which can be applied to a valve timing control device of an internal combustion engine and the like, for controlling fluid pressure.

### BACKGROUND ART

As a prior art solenoid valve, there has been proposed a solenoid valve as described in the following Patent document 1.

That is, in the above-mentioned solenoid valve, a check valve is provided in the fluid introduction part of a valve body and arranged upstream of a filter, for preventing back-flow of fluid at the introduction part.

### CITATION LIST

### Patent Literature

Patent document 1: EP1447602

### SUMMARY OF INVENTION

### Technical Problem

However, in the previously-discussed prior art solenoid valve, the filter is arranged downstream of the check valve, and thus there is a tendency for foreign matter, which is contained in fluid, to be jammed or bitten between the valve element of the check valve and the filter, thus deteriorating a seal performance of the check valve.

It is, therefore, in view of the previously-described drawbacks of the prior art, an object of the invention to provide a solenoid valve capable of suppressing a seal performance of a check valve from deteriorating due to biting of foreign matter.

### Solution to Problem

In order to accomplish the aforementioned and other objects, according to the present invention, there is provided a solenoid valve equipped with a filter member having an outer periphery constructed by a frame and configured to suppress entry of foreign matter contained in working fluid, and a check valve having a part structured integrally with the frame and configured to open and close by movement of the check valve out of and into abutted-engagement with either one of an inner peripheral surface of the frame and an outer peripheral surface of the frame, thereby limiting or restricting back-flow of the working fluid, wherein the check valve is arranged downstream of the filter member with respect to a free flow of the working fluid.

### Advantageous Effects of Invention

According to the present invention, the check valve is arranged downstream of the filter member, and thus it is possible to filter or purify foreign matter contained in working fluid by means of the filter member upstream of the check valve. Hence, it is possible to suppress a trouble of causing undesirable biting of foreign matter within the check valve as much as possible. As a result of this, it is possible to maintain a good seal performance of the check valve.

### BRIEF DESCRIPTION OF DRAWINGS

FIG. 1 is a hydraulic circuit diagram illustrating a valve timing control device to which a solenoid valve of the invention is applied.

FIG. 2 is a perspective view of the solenoid valve shown in FIG. 1.

FIG. 3 is a cross-sectional view illustrating a mounting manner of the solenoid valve shown in FIG. 2.

FIG. 4 is an enlarged view illustrating the essential part of the solenoid valve of FIG. 1.

FIG. 5 is a development view illustrating a first embodiment of a filter member according to the invention.

FIG. 6 is a perspective view illustrating an assembled state of the filter member shown in FIG. 5.

FIG. 7 is a cross-sectional view taken along the line A-A of FIG. 3, FIG. 7(a) showing a valve-open state of the check valve, and FIG. 7(b) showing a valve-closed state of the check valve.

FIG. 8 is a cross-sectional view of a modification modified from the first embodiment according to the invention and similar to the cross section of FIG. 7, FIG. 8(a) showing a valve-open state of the modified check valve, and FIG. 8(b) showing a valve-closed state of the modified check valve.

FIG. 9 is a perspective view illustrating a second embodiment of a filter member of a solenoid valve according to the invention, as viewed from the front side of the filter member.

FIG. 10 is a perspective view illustrating the filter member of the solenoid valve of the second embodiment, as viewed from the back side of the filter member.

FIG. 11 is a cross-sectional view of the second embodiment and similar to the cross section of FIG. 7, FIG. 11(a) showing a valve-open state of the check valve of the second embodiment, and FIG. 11(b) showing a valve-closed state of the check valve of the second embodiment.

FIG. 12 is a perspective view illustrating a filter member of a solenoid valve of a modification modified from the second embodiment according to the invention, as viewed from the front side of the filter member.

FIG. 13 is a perspective view illustrating the filter member of the solenoid valve of the modification of the second embodiment, as viewed from the back side of the filter member.

FIG. 14 is a cross-sectional view of the modification of the second embodiment and similar to the cross section of FIG. 7, FIG. 14(a) showing a valve-open state of the check valve of the modification, and FIG. 14(b) showing a valve-closed state of the check valve of the modification.

FIG. 15 is a perspective view illustrating a third embodiment of a filter member of a solenoid valve according to the invention, as viewed from the back side of the filter member.

FIG. 16 is a perspective view illustrating the filter member of the solenoid valve of the third embodiment, as viewed from the front side of the filter member.

### DESCRIPTION OF EMBODIMENTS

Respective embodiments of a solenoid valve according to the invention are hereinafter described in detail with reference to the drawings. By the way, in the respective embodiments, the solenoid valve is exemplified in a hydraulic valve timing control device of an internal combustion engine (an engine) in a similar manner to the prior art.

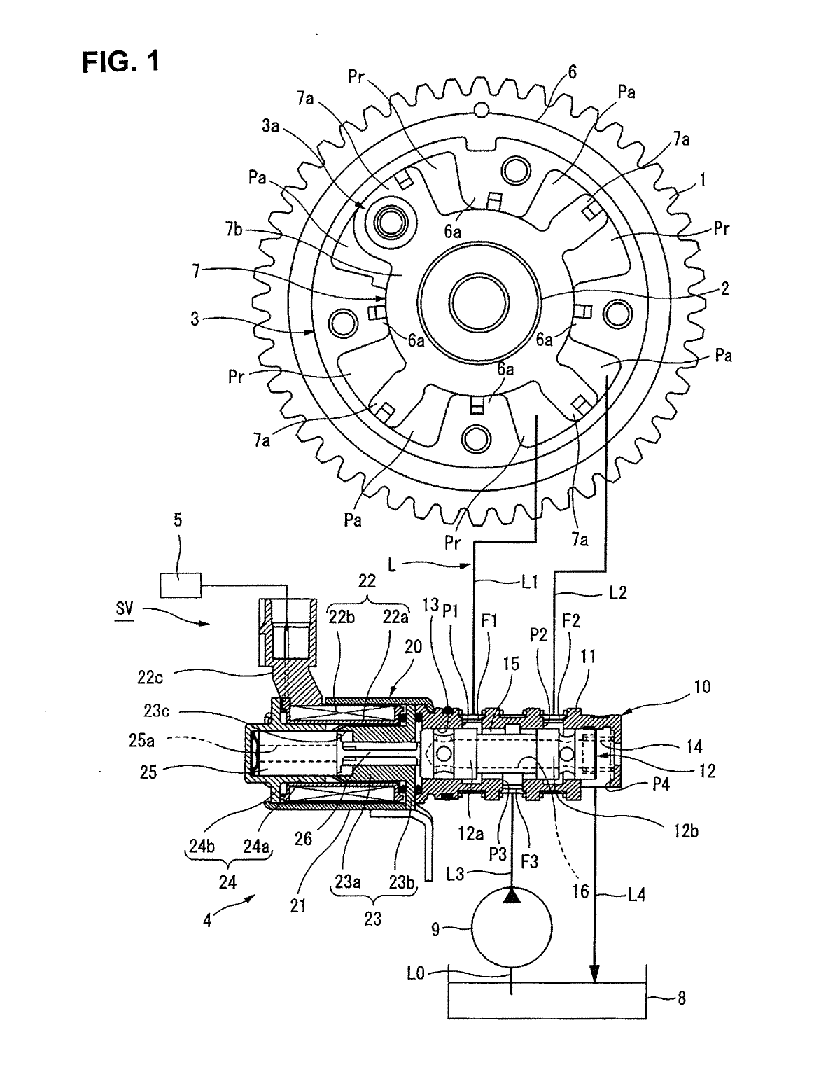

First of all, the hydraulic valve timing control device, to which the solenoid valve of the invention is applied, is hereunder explained. As shown in FIG. 1, the valve timing control device is comprised of a timing sprocket 1, a camshaft 2, a phase change mechanism 3, a hydraulic supply-discharge means 4, and an electronic control unit 5. The timing sprocket is rotationally driven by a crankshaft of an engine (not shown) via a timing chain. The camshaft is provided to be rotatable relative to the timing sprocket 1. The phase change mechanism is interposed between the camshaft 2 and the timing sprocket 1 for changing a relative phase between them by hydraulic pressure. The hydraulic supply-discharge means is provided to supply and discharge hydraulic pressure to and from the phase change mechanism 3. The electronic control unit is provided to control operation of the hydraulic supply-discharge means 4.

Phase change mechanism 3 is mainly comprised of a cylindrical housing 6 and a vane rotor 7. The cylindrical housing is integrally formed on the inner peripheral side of timing sprocket 1. The vane rotor is fixedly connected to one axial end of camshaft 2 from the axial direction and rotatably housed in the housing 6. That is, the phase change mechanism is configured such that a relative phase of vane rotor 7 with respect to housing 6 can be changed by supply/discharge of hydraulic pressure to and from each phase-retard chamber Pr and by supply/discharge of hydraulic pressure to and from each phase-advance chamber Pa. Phase-retard chambers Pr and phase-advance chambers Pa are defined and partitioned by four shoes 6a and four vanes 7a associated with the respective shoes 6a. The four shoes are formed on the inner periphery of housing 6 and configured to protrude inward such that each of the shoes is kept in sliding-contact with the outer peripheral surface of the annular root 7b of vane rotor 7. On the other hand, the four vanes are formed on the outer periphery of vane rotor 7 and configured to protrude outward such that the vanes and the shoes are alternately arranged and associated with each other. Therefore, a relative phase of camshaft 2 to timing sprocket 1 (the crankshaft) can be changed. By the way, one of vanes 7a is equipped with a lock mechanism 3a for restricting free rotation of vane rotor 7 on the maximum phase-retard side, thereby stabilizing revolution speeds when starting the engine or during idling operation.

Hydraulic supply-discharge means 4 is mainly constructed by a pump 9, a solenoid valve SV, and hydraulic oil passages L. The pump serves as a hydraulic pressure supply source (a fluid pressure source) that force-feeds working fluid (hydraulic oil) stored in an oil pan 8. Solenoid valve SV, serving as a fluid-flow passage switching valve, is responsive to a control signal from the electronic control unit 5, for supplying working fluid force-fed by the pump 9 to one of the phase-retard chamber Pr and the phase-advance chamber Pa and for discharging working fluid from the other of the phase-retard chamber Pr and the phase-advance chamber Pa into the oil pan 8. Hydraulic oil passages L are fluid-flow passages for fluid-communications among the solenoid valve SV, the oil pan 8, each phase-retard chamber Pr, each phase-advance chamber Pa, and the like.

Hydraulic oil passages L is comprised of a phase-retard passage L1, a phase-advance passage L2, an inlet passage L0, an introduction passage L3, and a drain passage L4. Phase-retard passage L1 is provided for fluid-communication between a phase-retard port P1 (described later) of solenoid valve SV and the phase-retard chamber Pr of phase change mechanism 3, and configured to supply and discharge working fluid to and from the phase-retard chamber Pr. Phase-advance passage L2 is provided for fluid-communication between a phase-advance port P2 (described later) of solenoid valve SV and the phase-advance chamber Pa of phase change mechanism 3, and configured to supply and discharge working fluid to and from the phase-advance chamber Pa. Inlet passage L0 is provided for fluid-communication between the oil pan 8 and an inlet port of pump 9. Introduction passage L3 is provided for fluid-communication between a discharge port of pump 9 and an introduction port P3 (described later) of solenoid valve SV, and configured to introduce working fluid discharged from the pump 9 into the phase change mechanism 3. Drain passage L4 is provided for fluid-communication between a drain port P4 (described later) of solenoid valve SV and the oil pan 8 and configured to return working fluid drained from the drain port P4 back to the oil pan 8. Solenoid valve SV is configured to selectively switch a state of fluid-communication between the phase-retard passage L1 and phase-advance passage L2, and the introduction passage L3 and drain passage L4.

Solenoid valve SV is a so-called sliding-spool type, four-port proportional electromagnetic switching valve. As shown in FIGS. 1 to 3, the solenoid valve is mainly constructed by a spool valve 10 and an electromagnetic solenoid 20. The spool valve is configured to switch a state of fluid-communication among respective ports P1 to P4 (described later) formed in a valve body 11 depending on an axial position of a spool 12, which is axially slidably accommodated in the valve body 11. The electromagnetic solenoid is integrally connected to the spool valve 10, and configured to drive the spool 12 through a movable iron core 25 by an electromagnetic force generated based on a control current from the electromagnetic control unit 5. electromagnetic solenoid is mounted and fixed on the engine through a bracket 21c attached onto the outer periphery of a yoke 21 (described later).

Spool valve 10 is comprised of the valve body 11 configured such that almost the whole of the valve body is inserted and fitted into a valve housing hole 30a bored in a cylinder head 30 of the engine and structured to have the ports P1-P4 (described later) connected to respective passages L1-L4, and the spool 12 slidably accommodated and installed in the valve body 11 and configured to switch a state of fluid-communication among respective ports P1-P4 depending on the axial position of the spool.

Valve body 11 is made of a non-magnetic metal material, for example aluminum, and formed into a substantially cylindrical shape. The valve body is formed at one end (a left-hand side end, viewing FIG. 1) with a diametrically-enlarged flanged portion 11a. The valve body is fixed to one end of electromagnetic solenoid 20 through the flanged portion by caulked-engagement of the flanged portion 11a with a plurality of first claw portions 17 formed at one end (a right-hand side end, viewing FIG. 1) of yoke 21 (described later) of electromagnetic solenoid 20.

An axially-extending spool housing chamber 13 is formed on the inner peripheral side of valve body 11 for slidably housing the spool 12. Phase-retard port P1 connected to the phase-retard passage L1, phase-advance port P2 connected to the phase-advance passage L2, introduction port P3 connected to the introduction passage L3, and drain port P4 connected to the drain passage L4 are formed in the peripheral wall of the spool housing chamber 13 as through holes each having a constant axial width in the circumferential direction.

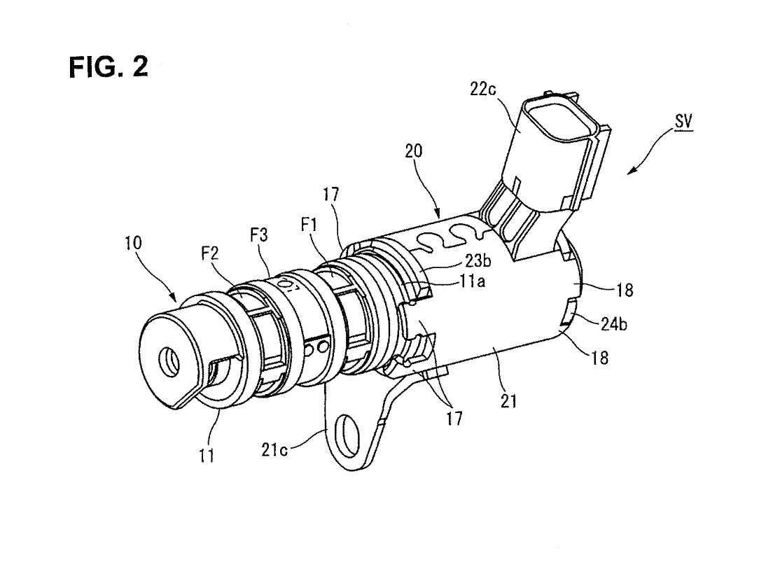

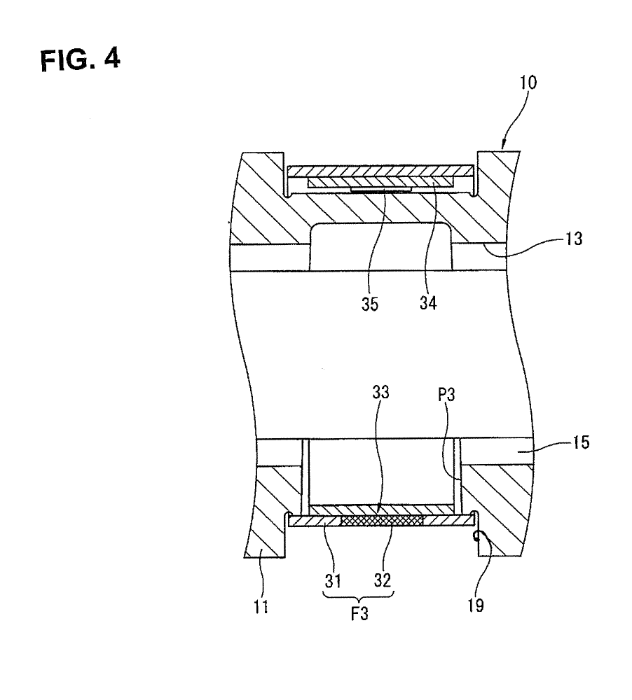

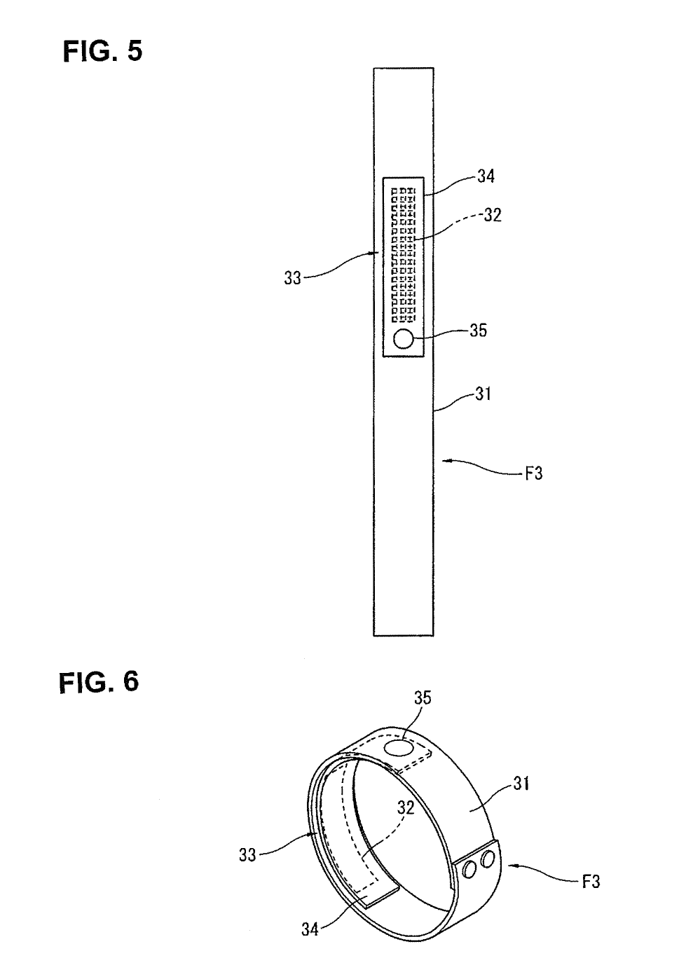

Hereupon, filter members F1-F3 are provided at respective ports P1-P3, for suppressing entry of foreign matter mixed in working fluid (hydraulic oil). As shown in FIGS. 4 to 7, for instance, filter member F3 is formed by a thin-walled metal plate made of stainless steel or brass, and comprised of a frame 31 constructing an outer edge (an outer frame) and a mesh filter 32 provided at an opening surrounded by the frame 31. An elongated belt-shaped filter member as shown in FIG. 5 is wound to an annular groove 19 cut and formed in the outer periphery of introduction port P3 as seen in FIG. 4. Thereafter, both ends of the belt-shaped filter member are superposed or overlapped, and then welded (projection-welded) together, as shown in FIG. 6. In this manner, the filter member is attached and fixed to the valve body 11 (see FIG. 2). By the way, a mesh size of the filter 32 is set within a range of approximately 70 to 100 meshes (approximately 0.15 to 0.20 mm in mesh opening).

A check valve 33 is provided on the inner peripheral side of filter member F3, that is, downstream of the filter 32 with respect to a free flow of working fluid flown from the introduction passage L3 into the valve body 11, for restricting an outflow of working fluid from the introduction port P3. Check valve 33 has a valve element 34 having a width set or dimensioned slightly less than the opening width of introduction port P3, and formed by a thin-walled belt-shaped metal plate, and configured as a longitudinally-curved valve element. The check valve is integrally connected to the filter member F3 by welding (projection-welding) one end of valve element 34 to the inner peripheral surface 31a of frame 31. By virtue of an elastic force (a restoring force) produced by the curved deflection, the outer peripheral surface 34a of valve element 34 is brought into elastic-contact with the inner peripheral surface 31a of frame 31, thereby restricting an outflow of working fluid from the inner peripheral side of the valve element to the outer peripheral side.

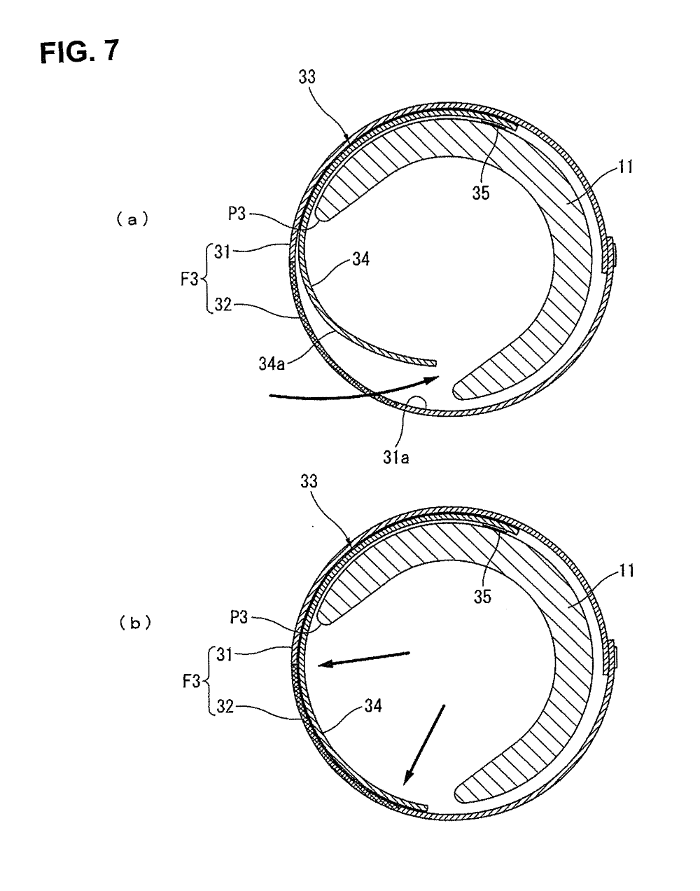

That is, when hydraulic pressure (fluid pressure) is applied to the introduction port P3 from the outer peripheral side of valve body 11 (see the arrow shown in FIG. 7(a)), check valve 33 functions as shown in FIG. 7(a), so as to permit an inflow of working fluid through the introduction port P3 into the valve body 11 by flexural deformation of the valve element 34 of check valve 33 on a welded portion 35 corresponding to the one end of the valve element and serving as a fulcrum such that the other end of the valve element moves away from the frame 31 of filter member F3. Conversely when hydraulic pressure is applied to the introduction port P3 from the inner peripheral side of valve body 11 (see the arrow shown in FIG. 7(b)), check valve 33 functions as shown in FIG. 7(b), so as to restrict an outflow of working fluid through the introduction port P3 out of the valve body 11 by bringing the valve element 34 of check valve 33 into press-contact with the frame 31 of filter member F3.

As seen in FIG. 1, spool 12 has two large-diameter lands, namely, the first land 12a and the second land 12b, which are configured to selectively switch a state of fluid-communication between the phase-retard port P1 and phase-advance port P2, and the introduction port P3 and drain port P4, depending on the axial position of the spool. The spool is slidably accommodated in the spool housing chamber 13 via these two lands. By the way, a coil spring 14 is elastically disposed between one end of the spool 12 and the other end wall (a right-hand side end, viewing FIG. 1) of valve body 11, such that the spool is permanently biased toward a first fixed iron core 23 by means of the coil spring 14. As a result of this, in a de-energized state of electromagnetic solenoid 20, spool 12 is positioned at the left-hand end (viewing FIG. 1) of spool housing chamber 13. Conversely when electromagnetic solenoid 20 becomes energized, spool 12 moves toward the right-hand side (viewing FIG. 1) of spool housing chamber 13 against the biasing force of coil spring 14.

In more detail, when electromagnetic solenoid 20 is kept in its de-energized state, spool 12 is positioned at the left-hand end of FIG. 1, fluid-communication between the phase-retard port P1 and the introduction port P3 is established through an annular passage 15 defined on the outer periphery of the reduced-diameter portion formed between the two lands 12a-12b, and simultaneously fluid-communication between the phase-advance port P2 and the drain port P4 is established through a hydraulic oil passage 16 bored in the spool 12. Conversely when electromagnetic solenoid 20 is energized and thus spool 12 moves toward the right-hand end of FIG. 1, fluid-communication between the phase-advance port P2 and the introduction port P3 is established through the annular passage 15, and simultaneously fluid-communication between the phase-retard port P1 and the drain port P2 is established through the hydraulic oil passage 16.

Electromagnetic solenoid 20 is comprised of the yoke 21, a coil unit 22, the first fixed iron core 23 and the second fixed iron core 24, the movable iron core 25, and a rod 26. Yoke 21 is made of a magnetic material and formed into a substantially cylindrical shape and constructs a casing (solenoid housing). Coil unit 22 is accommodated on the inner peripheral side of yoke 21 and formed by winding a coil 22b on the outer periphery of a bobbin 22a. The first fixed iron core 23 is fixed through a flanged portion 23b formed at its one end to the one axial end of yoke 21. The second fixed iron core 24 is fixed through a flanged portion 24b formed at its one end to the other axial end of yoke 21. A cylindrical-hollow portion 23a formed at another end of the first fixed iron core and a cylindrical-hollow portion 24a formed at another end of the second fixed iron core are accommodated on the inner peripheral side of coil unit 22, such that the cylindrical-hollow portion of the first fixed iron core and the cylindrical-hollow portion of the second fixed iron core are arranged to be axially opposed each other. Each of the first and second fixed iron cores is made of a magnetic material. Movable iron core 25 is made of a magnetic material and slidably accommodated and disposed on the inner peripheral side of the second fixed iron core 24. Rod 26 is accommodated on the inner peripheral side of the first fixed iron core 23 and configured such that one axial end face of the rod abuts on the other end face of spool 12. The other end face of the rod is configured to abut on one end face of the movable iron core 25. The rod is made of a non-magnetic material.

Yoke 21 is made of a plate-like magnetic metal material. The plate-like magnetic material is rounded, and then its circumferentially-opposed ends are both joined together and formed into a substantially cylindrical shape, which is configured to surround the outer periphery of coil unit 22. Yoke 21 is formed at its both axial ends with a plurality of circumferentially-equidistant spaced protruding first claw portions 17 and a plurality of circumferentially-equidistant spaced protruding second claw portions 18. The first claw portions 17 are fixed to the flanged portion 11a of valve body 11 by caulked-engagement with the outside end edge of the flanged portion 11a. The second claw portions 18 are fixed to the flanged portion 24b of the second fixed iron core 24 by caulked-engagement with the outside end edge of the flanged portion 24b.

Each of the first fixed iron core 23 and the second fixed iron core 24 are made of a magnetic metal material, for example iron and the like, and formed into a substantially cylindrical shape. The first fixed iron core 23 and the second fixed iron core 24 are arranged to be axially opposed each other. The first fixed iron core 23 has the cylindrical-hollow portion 23a accommodated on the inner peripheral side of coil unit 22 and the diametrically-enlarged flanged portion (the diametrically-enlarged shouldered portion) 23b formed at the outside end portion of the cylindrical-hollow portion 23a. The second fixed iron core 24 has the cylindrical-hollow portion 24a accommodated on the inner peripheral side of coil unit 22 and the diametrically-enlarged flanged portion (the diametrically-enlarged shouldered portion) 24b formed at the outside end portion of the cylindrical-hollow portion 24a. The first fixed iron core 23 is fixed to the yoke 21 through the flanged portion 23b by caulking the first claw portions 17 of the yoke, while being sandwiched between the bobbin 22a and the valve body 11. Thus, the first fixed iron core is magnetic-coupled to the peripheral wall of yoke 21. On the other hand, the second fixed iron core 24 is fixed to the yoke 21 through the flanged portion 24b by caulking the second claw portions 18 of the yoke and fastening the second fixed iron core together with the bobbin 22a. Thus, the second fixed iron core is magnetic-coupled to the peripheral wall of yoke 21.

Coil unit 22 is formed by winding the coil 22b on the outer periphery of bobbin 22a, which is made of a resin material and formed into a substantially cylindrical shape. The coil unit 22 is connected through a resin-made connector 22c fixed to the other end (a left-hand side end, viewing FIG. 1) of yoke 21 and a harness (not shown) connected to the connector to the electronic control unit 5. A magnetic path is formed by way of the yoke 21, the first fixed iron core 23, the second fixed iron core 24, and the movable iron core 25, by power fed from electronic control unit 5, and thus a magnetic attraction force is generated between the first fixed iron core 23 and the movable iron core 25.

Hereupon, electronic control unit 5 is configured to detect an engine operating condition based on signals from various sensors, such as a crank angle sensor for detecting engine speed, an airflow meter for detecting an intake air quantity, and the like. The electronic control unit is also configured to perform switching of the state of fluid-communication among respective ports P1-P4 (i.e., the switching of the state of fluid-communication among respective hydraulic oil passages L) by feeding or cutting off a control current to the coil 22b of solenoid valve SV depending on the engine operating condition.

Movable iron core 25 is made of a magnetic metal material, for example iron and the like, and formed into a substantially cylindrical shape, which is configured to have an outside diameter slightly less than an inside diameter of the second fixed iron core 24. The movable iron core is coaxially arranged in the cylindrical-hollow portion 24a of the second fixed iron core 24 through a cap 29 made of a non-magnetic material. The movable iron core is configured to form or define a so-called air gap (a main gap) between the movable iron core and a recessed portion 23c bored in the top end of the cylindrical-hollow portion of the first fixed iron core 23. A so-called breathing hole 25a, which is set or configured to have a predetermined inside diameter, is formed through the movable iron core 25 and configured as a through hole formed along the axial direction of the movable iron core 25. Escaping the working fluid filled in the main gap by way of the breathing hole 25a toward the second fixed iron core 24 permits or ensures axial movement of movable iron core 25 in the working fluid. That is, movable iron core 25 is configured to be rotatable relative to the second fixed iron core 24 on the inner peripheral side of the second fixed iron core 24, while being guided by the inner peripheral wall. During energization of the coil 22b, the movable iron core is attracted toward the first fixed iron core 23 by a magnetic flux induced in the first fixed iron core 23. Hence, the movable iron core is configured to be axially displaced within a predetermined axial range until the one end face (the right-hand end face, viewing FIG. 1) of the movable iron core is brought into abutted-engagement with the inside surface (the bottom face) of the recessed portion 23c of the first fixed iron core 23.

Rod 26 is made of a non-magnetic material, such as stainless steel, aluminum, resin and the like, and formed into a bottomed cylindrical shape, which is configured to open into the movable iron core 25. Rod 26 is configured to be movable together with the movable iron core 25 by a pushing force produced based on the biasing force of coil spring 14. Radially-inward recessed axial grooves 26a are formed in the outer periphery of rod 26 and substantially equidistant-spaced from each other in the circumferential direction. The right-hand end (viewing FIG. 1) of each of the radially-inward recessed axial grooves 26a, facing the second fixed iron core 24, is formed with a radial communication hole 26b configured to communicate the inner circumference and the outer circumference of rod 26. Escaping working fluid, which is flown from the side of spool valve 10 into each of the axial grooves 26a, by way of the radial communication hole 26b into the inner peripheral side of rod 26, and further escaping the working fluid through the inner peripheral section of rod 26 into the breathing hole 25a of movable iron core 25, permits or ensures axial movement of rod 26 in the working fluid.

Assembling and installing processes of solenoid valve SV of the embodiment are hereunder explained in reference to FIGS. 2-5.

First of all, electromagnetic solenoid 20 is fixedly connected to the valve body 11, and thereafter filters F1-F3 are installed onto respective ports P1-P3. In particular, regarding the introduction port P3, the belt-shaped filter member F3, to which check valve 33 (valve element 34) has been projection-welded beforehand as shown in FIG. 5, is wound onto the outer periphery of the introduction port P3 (i.e., the annular groove 19), while the filter 32 is superposed on the introduction port P3 as shown in FIG. 4. Thereafter, both ends of the belt-shaped filter member are overlapped and projection-welded together as shown in FIG. 2, for fixing the filter member in place. In this manner, the assembling work of solenoid valve SV is completed.

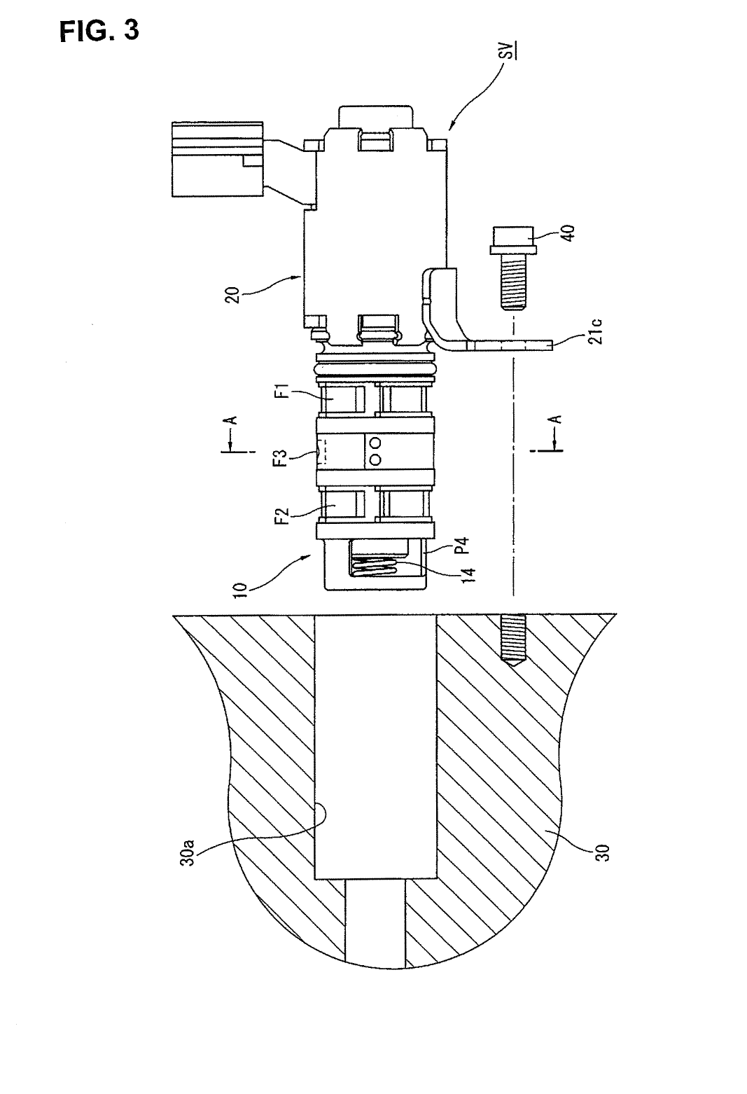

After this, regarding the assembled solenoid valve SV, as shown in FIG. 3, the top end (the axial end side being opposite to the electromagnetic solenoid 20) of spool valve 10 is inserted and fitted into the valve housing hole 30a of cylinder head 30. Thereafter, electromagnetic solenoid 20 is retained to the cylinder head 30 through the bracket 21c with a bolt 40. In this manner, the installing work of solenoid valve SV is completed.

By the way, in the case of a check valve used in the prior art solenoid valve, the check valve is interposed between the filter member F3 and the valve housing hole 30a. The check valve is configured such that its valve element is kept in elastic-contact with the opening edge of the introduction port L1, which is opened into the valve housing hole 30a. With the previously-discussed configuration, on one hand, this type of check valve permits flow through the introduction port P3 by the hydraulic pressure from the side of introduction passage L3. On the other hand, the check valve restricts a flow through the introduction port P3 by the hydraulic pressure from the side of a hydraulic-pressure supply object (corresponding to the valve timing control device of the shown embodiment) to which hydraulic pressure is supplied. Therefore, when installing the solenoid valve, under a specific state where the valve element of the check valve, which is located on the outer peripheral side of the filter member F3, has been pushed and contracted toward the inner peripheral side against its elastic force, the spool valve 10 has to be inserted and fitted into the valve housing hole 30a. This requires a troublesome installing work.

In contrast to the above, in the case of the solenoid valve SV of the shown embodiment, check valve 33 is configured such that the valve element of the check valve is brought into elastic-contact with the inner peripheral surface 31a of frame 31 of filter member F3 on the downstream side of the filter member F3. Hence, under a state where check valve 33 has been interposed between the filter member F3 and the valve body 11 beforehand, spool valve 10 can be inserted and fitted into the valve housing hole 30a, thereby installing the solenoid valve on the cylinder head 30. That is, when installing the solenoid valve SV, a good installing workability of the solenoid valve can be ensured without an additional labor such as pushing and contracting work of valve element 34.

The operation and specific effects of solenoid valve SV of the embodiment are hereunder explained in reference to FIG. 7.

When supplying working fluid to phase-retard port P1 or phase-advance port P2, that is, in a state where hydraulic pressure in the introduction passage L3 is high relatively to hydraulic pressure in phase-retard passage L1 or phase-advance passage L2, as shown in FIG. 7(a), the top end side of valve element 34 flexurally deforms inward away from the inner peripheral surface 31a of frame 31, based on the hydraulic pressure on the side of introduction passage L3, thereby opening the check valve. Hence, working-fluid flow by way of a clearance space C defined between the valve element 34 and the frame 31 at the introduction port P3 is permitted for supplying and draining working fluid to and from each of ports P1, P2.

Conversely, in a state where hydraulic pressure in phase-retard passage L1 or phase-advance passage L2 is high relatively to hydraulic pressure in the introduction passage L3, as shown in FIG. 7(b), valve element 34 is brought into press-contact with the inner peripheral surface 31a of frame 31 of filter member F3, based on the hydraulic pressure on the side of each phase-change passage L1, L2, thereby closing the check valve. Hence, the check valve serves to restrict an outflow (back-flow) of working fluid from the inside of valve body 11 through the introduction port P3 to the outside of valve body 11.

As set forth above, according to the shown embodiment, check valve 33 is arranged on the downstream side of filter member F3, and hence it is possible to filter or purify foreign matter contained in working fluid by means of the filter member F3 located on the upstream side of check valve 33. Therefore, it is possible to suppress a trouble of causing undesirable biting of foreign matter between the valve element 34 and the filter member F3 (the frame 31) within the check valve 33, as much as possible. As result of this, it is possible to maintain a good seal performance of the check valve 33.

Additionally, in the case of the first embodiment, the frame 31 and the valve element 34 are both made of a metal material. Hence, it is possible to suppress settling (weakening) and/or breakage of the valve element 34 from occurring due to excessive hydraulic pressure acting on the valve element 34 and/or repeated elastic deformation of the valve element 34. Furthermore, the frame 31 and the valve element 34 are connected to each other by welding, thereby reducing the risk of breakage of the connected portion. This ensures an excellent durability of check valve 33.

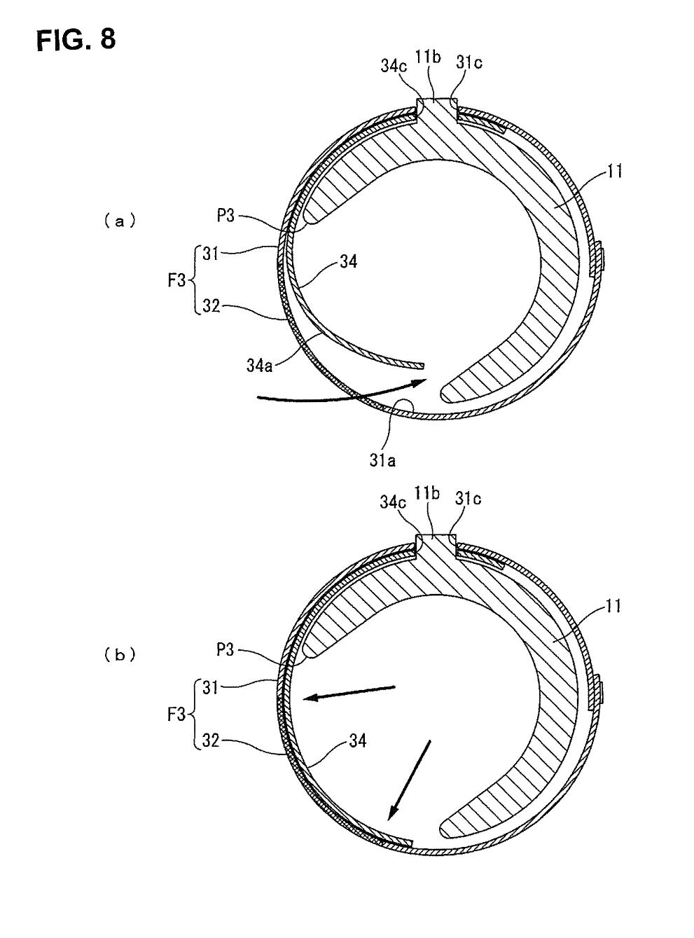

Referring to FIG. 8, there is shown the modification modified from the first embodiment of the solenoid valve according to the invention. In the modification, the method for fixing the check valve 33 of the first embodiment is modified. The other fundamental configuration of the modification except for the modified fixing method is similar to the first embodiment. Thus, in explaining the modification, regarding the same configuration and operation as the first embodiment, the same reference signs used to designate elements in the first embodiment will be applied to the corresponding elements used in the modification, while detailed description of the same reference signs will be omitted because the above description thereon seems to be self-explanatory.

That is, in the solenoid valve SV of the modification, on one hand, an engagement protrusion 11b having a circular cross section is integrally formed on the outer periphery of valve body 11 so as to protrude from the outer periphery. On the other hand, an engagement hole 31c and an engagement hole 34c are formed in the frame 31 of filter member F3 and the valve element 34 of check valve 33 respectively. These engagement holes 31c, 34c are both configured to be engageable with the engagement protrusion 11b. Hence, the engagement protrusion 11b enables circumferential positioning between the valve element and the frame of the filter member. That is, instead of welding the valve element 34 of check valve 33 to the frame 31, the valve element of the check valve is configured to be sandwiched between the frame 31 and the valve body 11.

Therefore, when assembling the filter member F3, first of all, the valve element 34 is temporarily assembled or installed on the valve body 11 by bringing the engagement hole 34c of valve element 34 into engagement with the engagement protrusion 11b of valve body 11. Thereafter, the belt-shaped filter member F3 is wound onto the outer periphery of the introduction port P3 (i.e., the annular groove 19, while circumferentially positioning the filter member F3 by engagement of the engagement hole 34c with the engagement protrusion 11b. Thereafter, both ends of the belt-shaped filter member are overlapped and welded (projection-welded) together. In this manner, the filter member F3 is fixed to the valve body 11, and simultaneously the valve element 34 is sandwiched and fixed between the valve body 11 and the filter member F3 by fixing the filter member to the valve body.

As appreciated from the above, also in the modification, check valve 33 is arranged on the downstream side of filter member F3, and thus the modification can provide the same operation and effects as the first embodiment. In particular, in the case of the modification, it is possible to easily but precisely assemble both the filter member F3 and the check valve 33 in place by virtue of the positioning action of the engagement protrusion 11b. Thus, there is a merit that the assembling workability of the solenoid valve SV can be further improved.

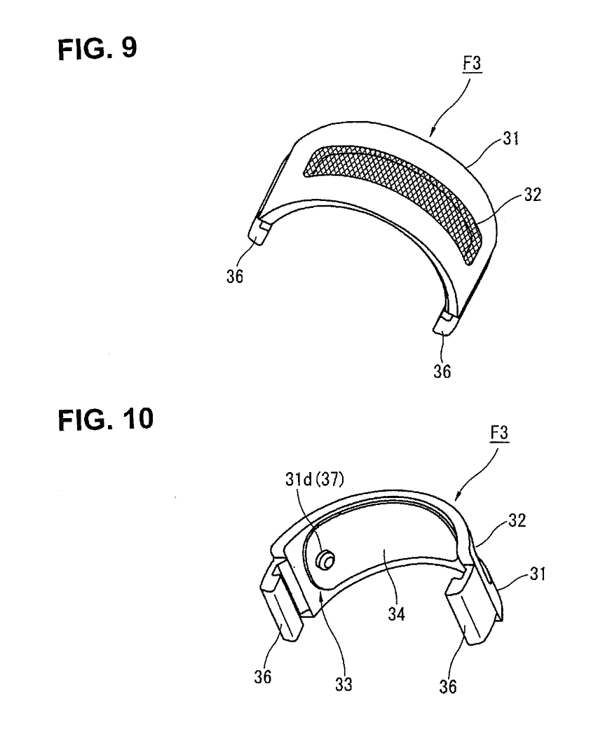

Referring to FIGS. 9-11, there is shown the second embodiment of the solenoid valve according to the invention. The second embodiment differs from the first embodiment, in that in the second embodiment the configuration of each of filter member F3 and check valve 33 of the first embodiment is modified. By the way, the other fundamental configuration of the second embodiment except for the modified configuration is similar to the first embodiment. Thus, in explaining the second embodiment, regarding the same configuration and operation as the first embodiment, the same reference signs used to designate elements in the first embodiment will be applied to the corresponding elements used in the second embodiment, while detailed description of the same reference signs will be omitted because the above description thereon seems to be self-explanatory.

That is, in the solenoid valve SV of the second embodiment, the frame 31 of filter member F3 is molded from a resin material, and has a pair of engagement claws 36, 36 formed at both ends in the longitudinal direction. The filter member is fixed to the valve body 11 by engagement between the pair of engagement claws and the valve body. By the way, regarding the check valve 33, the valve element 34 is made of a metal material, and fixed to the frame 31 made of the resin material by caulked-engagement with the frame. More concretely, on one hand, the frame 31 of filter member F3 has a caulked protrusion 31d having a predetermined configuration. On the other hand, the valve element 34 of check valve 33 has an engagement hole 34c associated with the caulked protrusion 31d and formed as a through hole. The tip of caulked protrusion 31d is inserted into the engagement hole 34c, and then the tip is heat-caulked and melted down, such that the check valve 33 is fixed to the filter member F3 beforehand.

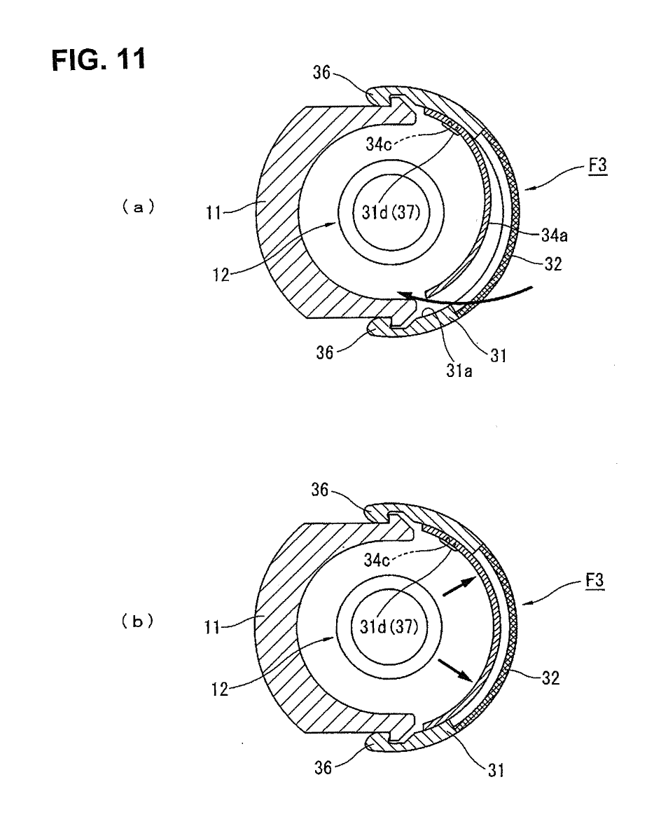

With the previously-discussed configuration, in a similar manner to the first embodiment, also in the second embodiment, in a state where hydraulic pressure in the introduction passage L3 is high relatively to hydraulic pressure in phase-retard passage L1 or phase-advance passage L2, as shown in FIG. 11(a), the other end of valve element 34 flexurally deforms inward away from the inner peripheral surface 31a of frame 31 on the caulked portion 37 (serving as a fulcrum) of the one end of valve element 34, based on the hydraulic pressure on the side of introduction passage L3, thereby opening the check valve. Conversely, in a state where hydraulic pressure in phase-retard passage L1 or phase-advance passage L2 is high relatively to hydraulic pressure in the introduction passage L3, as shown in FIG. 11(b), the whole of the outer peripheral surface 34a of valve element 34 is brought into press-contact with the inner peripheral surface 31a of frame 31, based on the hydraulic pressure on the side of each phase-change passage L1, L2, thereby closing the check valve.

Therefore, the second embodiment is somewhat inferior to the first embodiment in durability as compared to the first embodiment employing the metal-made filter member F3 (the metal-made frame 31) and the metal-made check valve 33. However, also in the second embodiment, check valve 33 is arranged on the downstream side of the filter member F3. Thus, the second embodiment can provide the fundamental operation and effects of the invention, that is, maintaining of a good seal performance, in a similar manner to the first embodiment.

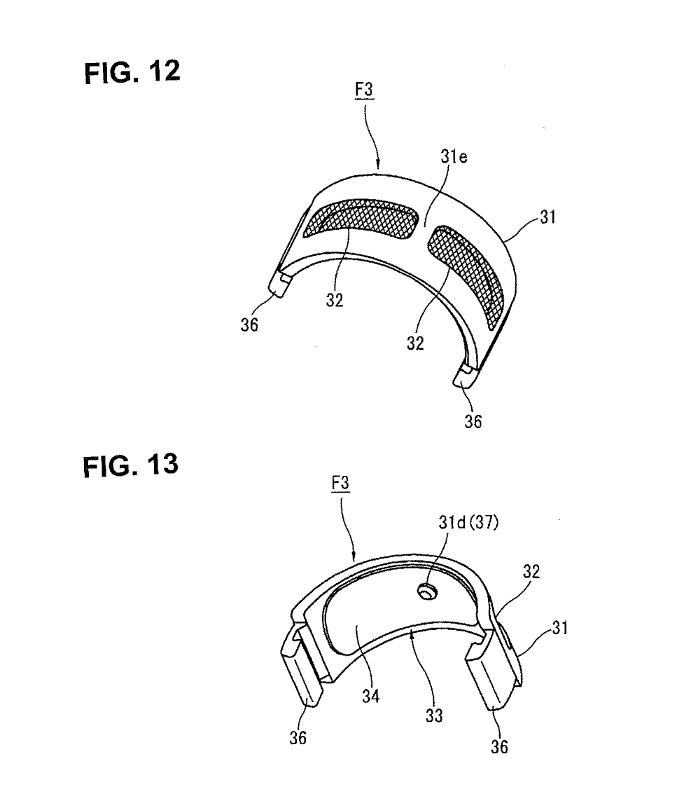

Referring to FIGS. 12 to 14, there is shown the modification modified from the second embodiment of the solenoid valve according to the invention. In the modification, the supporting point of check valve 33 is modified. The other fundamental configuration of the modification except for the modified supporting point is similar to the second embodiment. Thus, in explaining the modification, regarding the same configuration and operation as the second embodiment, the same reference signs used to designate elements in the second embodiment will be applied to the corresponding elements used in the modification, while detailed description of the same reference signs will be omitted because the above description thereon seems to be self-explanatory.

That is, in the solenoid valve SV of the modification, the frame 31 is molded from a resin material in a similar manner to the second embodiment. A laterally-extending intermediate cross beam 31e is provided at a midpoint of the resin-molded frame in a manner so as to spit the opening of the frame into two opening sections. The previously-discussed caulked protrusion 31d is formed on the intermediate cross beam 31e so as to protrude from the inside face of intermediate cross beam 31e. The check valve 33 is heat-caulked and fixed to the intermediate cross beam 31e of frame 31 such that a substantially center section of valve element 34 is supported as a supporting point. By the way, filters 32 are attached to the respective opening sections split by the intermediate cross beam 31e.

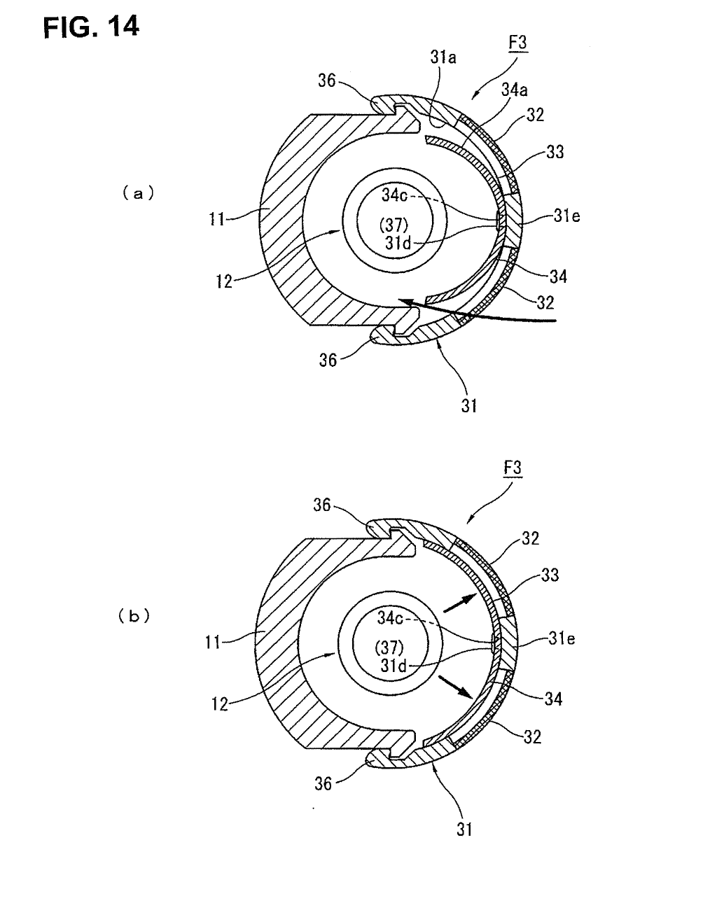

With the previously-discussed configuration, in the modification, in a state where hydraulic pressure in the introduction passage L3 is high relatively to hydraulic pressure in phase-retard passage L1 or phase-advance passage L2, as shown in FIG. 14(a), both end sides of valve element 34 flexurally deform inward away from the inner peripheral surface 31a of frame 31 with the caulked portion 37 (serving as a fulcrum) provided at the substantially center section of valve element 34, based on the hydraulic pressure on the side of introduction passage L3, thereby opening the check valve. Conversely, in a state where hydraulic pressure in phase-retard passage L1 or phase-advance passage L2 is high relatively to hydraulic pressure in the introduction passage L3, as shown in FIG. 14(b), the whole of the outer peripheral surface 34a of valve element 34 is brought into press-contact with the inner peripheral surface 31a of frame 31, based on the hydraulic pressure on the side of each phase-change passage L1, L2, thereby closing the check valve.

Therefore, also in the modification, check valve 33 is arranged on the downstream side of filter member F3, and thus the modification can provide the same operation and effects as the second embodiment. In particular, in the case of the modification, check valve 33 is configured such that its valve element 34 is supported at a substantially central position of frame 31. Hence, in the modification, it is possible to reduce a flow resistance of working fluid when opening the valve element, as compared to the valve element of the second embodiment supported at one end. Hence, it is possible to reduce a pressure loss of working fluid during the valve-open period. Thus, there is a merit that the better supplying and draining operation of working fluid through the check valve can be assured.

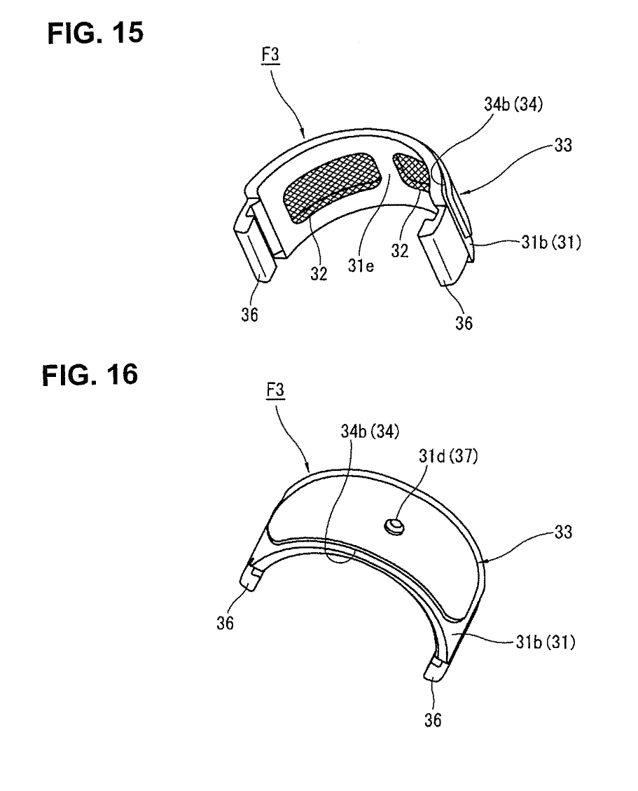

Referring to FIGS. 15-16, there is shown the third embodiment of the solenoid valve according to the invention. The third embodiment differs from the second embodiment, in that check valve 33 is arranged on the outer peripheral side of filter member F3.

That is, the third embodiment shows a specific case in which a working-fluid flow direction is opposite to the direction of flow of working fluid in the first and second embodiments. In the third embodiment, a caulked protrusion 31d is formed on the outer peripheral portion of the intermediate cross beam 31e of frame 31, and thus the valve element 34 is located on the outer peripheral side of frame 31. Hence, the check valve is configured such that the inner peripheral surface 34b of valve element 34 is brought into elastic-contact with the outer peripheral surface 31b of frame 31.

In the case of the previously-discussed configuration, in a state where hydraulic pressure on the inner peripheral side of filter member F3 is high relatively to hydraulic pressure on the outer peripheral side of filter member F3, both end sides of valve element 34 flexurally deform outward away from the outer peripheral surface 31b of frame 31 with the caulked portion 37 (serving as a fulcrum) provided at the substantially center section of valve element 34, based on the hydraulic pressure on the inner peripheral side, thereby opening the check valve. Conversely in a state where hydraulic pressure on the outer peripheral side of filter member F3 is high relatively to hydraulic pressure on the inner peripheral side of filter member F3, the whole of the inner peripheral surface 34b of valve element 34 is brought into press-contact with the outer peripheral surface 31b of frame 31, based on the hydraulic pressure on the outer peripheral side, thereby closing the check valve.

Therefore, also in the third embodiment, check valve 33 is arranged on the downstream side of filter member F3, and thus the third embodiment can provide the same operation and effects as the first and second embodiments.

While the foregoing is a description of the preferred embodiments carried out the invention, it will be understood that the invention is not limited to the particular embodiments shown and described herein, but that various changes and modifications may be made without departing from the scope or spirit of this invention. As a matter of course, regarding detailed configurations of spool valve 10 and electromagnetic solenoid 20, such as positions and shapes of respective ports P1-P4, each of which directly forms no part of the present invention, various changes and modification may be made. Furthermore, regarding the filter member F3 and the check valve 33, which directly form elements of the present invention, for instance, depending on various specifications of objects to which the invention can be applied, the configuration of frame 31 and the support means for supporting the valve element 34 may be changed and modified without departing from the scope or spirit of this invention.

As an example, in fixing the valve element 34 made of a metal material to the frame 31 made of a resin material, in several embodiments as discussed previously, the valve element 44 is fixed to the frame 31 by caulked-engagement with the frame. In lieu of such caulked-engagement, for instance, in molding the frame 31 of filter member F3, the valve element 34 may be insert-molded. That is, the frame 31 and the valve element 34 may be integrally molded by insert-molding. With this configuration, the need for an assembling process of check valve 33 can be eliminated. Thus, it is possible to further improve the productivity of solenoid valve SV.

The other technical ideas grasped from the embodiments shown and described are enumerated and explained, as follows:

(a) The solenoid valve as recited in claim 3, is characterized in that

the frame is wound onto the outer periphery of the valve body, and both ends of the frame are overlapped and welded together.

(b) The solenoid valve as recited in claim 4, is characterized in that

the check valve is fixed to the frame by caulked-engagement.

With the previously-discussed configuration, it is possible to easily fix the check valve to the frame, thus improving the productivity of the solenoid valve.

(c) The solenoid valve as recited in claim 7, is characterized in that the check valve is fixed to one end of the frame.

(d) The solenoid valve as recited in claim 7, is characterized in that

the check valve is fixed to a substantially central position of the frame.

(e) The solenoid valve as recited in items (c) or (d), is characterized in that

the check valve is heat-caulked and fixed to the frame.

(f) The solenoid valve as recited in items (c) or (d), is characterized in that

the check valve is insert-molded and fixed to the frame.

As set forth above, by integrally molding the check valve and the filter member, the need for an assembling process of the check valve can be eliminated. Thus, it is possible to further improve the productivity of the solenoid valve.

(g) The solenoid valve as recited in claim 7, is characterized in that

the frame has a pair of engagement claws formed at both ends in a longitudinal direction of the frame; and

the frame is fixed to the valve body by engagement between the pair of engagement claws and the valve body.

(h) The solenoid valve as recited in claim 8, is characterized in that

the check valve is configured such that one end side of the check valve flexurally deforms with respect to a fixed position of the check valve to the frame, the one end side being opposite to the fixed position.

### REFERENCE SIGNS LIST

SV . . . Solenoid valve
31 . . . Frame
31a . . . Inner peripheral surface
31b . . . Outer peripheral surface
33 . . . Check valve
F3 . . . Filter member

1. A solenoid valve comprising:
a filter member having an outer periphery constructed by a frame and configured to suppress entry of foreign matter contained in working fluid; and
a check valve having a part structured integrally with the frame and configured to open and close by movement of the check valve out of and into abutted-engagement with either one of an inner peripheral surface of the frame and an outer peripheral surface of the frame, thereby restricting back-flow of the working fluid,
wherein the check valve is arranged downstream of the filter member with respect to a free flow of the working fluid.

2. The solenoid valve as recited in claim 1, which further comprises:
a valve body having an introduction part to which the working fluid is introduced from an external part through an introduction passage communicating with a fluid pressure source,
wherein the filter member is provided at the introduction part, and
wherein the check valve is arranged along the inner peripheral surface of the frame, and a part of the check valve is fixed to the inner peripheral surface of the frame.

3. The solenoid valve as recited in claim 2, wherein:
the frame and the check valve are both made of a metal material.

4. The solenoid valve as recited in claim 3, wherein:
the part of the check valve fixed to the frame is kept in contact with an outer peripheral surface of the valve body.

5. The solenoid valve as recited in claim 4, wherein:
the check valve is welded to the frame.

6. The solenoid valve as recited in claim 4, wherein:
the valve body has a protrusion protruded from an outer periphery of the valve body; and
the check valve is fixed to the frame by engagement of the check valve with the protrusion.

7. The solenoid valve as recited in claim 2, wherein:
the check valve is fixed to the frame by caulked-engagement.

8. The solenoid valve as recited in claim 3, wherein:
the frame is wound onto an outer periphery of the valve body, and both ends of the frame are overlapped and welded together.

9. The solenoid valve as recited in claim 2, wherein:
the frame is made of a resin material; and
the check valve is made of a metal material.

10. The solenoid valve as recited in claim 9, wherein:
the check valve is fixed to one end of the frame.

11. The solenoid valve as recited in claim 10, wherein:
the check valve is heat-caulked and fixed to the frame.

12. The solenoid valve as recited in claim 10, wherein:
the check valve is fixed to the frame by insert-molding.

13. The solenoid valve as recited in claim 9, wherein:
the check valve is fixed to a substantially central position of the frame.

14. The solenoid valve as recited in claim 9, wherein:
the frame has a pair of engagement claws formed at both ends in a longitudinal direction of the frame; and
the frame is fixed to the valve body by engagement between the pair of engagement claws and the valve body.

15. The solenoid valve as recited in claim 1, which further comprises:
a valve body having an introduction part to which the working fluid is externally introduced through an introduction passage communicating with a fluid pressure source,
wherein the filter member is provided at the introduction part, and
wherein the check valve is configured to:
permit an inflow of the working fluid through the introduction part into the valve body by flexural deformation of the check valve with movement of the check valve away from the frame, when fluid pressure is applied from an outer peripheral side of the valve body to the introduction part, and
restrict an outflow of the working fluid through the introduction part out of the valve body by bringing an outer peripheral surface of the check valve into press-contact with an inner peripheral surface of the frame, when fluid pressure is applied from an inner peripheral side of the valve body to the introduction part.

16. The solenoid valve as recited in claim 15, wherein:
the check valve is configured such that both end sides of the check valve flexurally deform with respect to a fixed position of the check valve to the frame.

17. The solenoid valve as recited in claim 15, wherein:
the check valve is configured such that one end side of the check valve flexurally deforms with respect to a fixed position of the check valve to the frame, the one end side being opposite to the fixed position.

18. A solenoid valve comprising:
a valve body having an introduction part connected to an introduction passage communicating with a fluid pressure source for introducing working fluid from an external part through the introduction passage, a plurality of supply-discharge parts connected to an object to which the working fluid is supplied and configured to supply and discharge the working fluid introduced through the introduction part, and a drain part connected to a drain passage for draining the working fluid to the external part;
a substantially circular-arc shaped filter member provided at the introduction part and having an outer periphery constructed by a frame;
a check valve arranged along an inner peripheral surface of the frame, and configured such that a part of the check valve is fixed to the inner peripheral surface of the frame, and that an outer peripheral surface of the check valve is kept in elastic-contact with the inner peripheral surface of the frame;
a spool axially movably accommodated on an inner peripheral side of the valve body, for switching a state of fluid-communication among the introduction part, the supply-discharge parts, and the drain part by axial movement of the spool;
an electromagnetic solenoid fixed to one axial end of the valve body, for attracting a movable iron core when energized and for causing the axial movement of the spool in an attraction direction; and
a biasing member for generating a biasing force in a direction opposite to the attraction direction of the movable iron core,
wherein the check valve is configured to open and close by movement of the outer peripheral surface of the check valve out of and into abutted-engagement with the inner peripheral surface of the frame.

19. A solenoid valve comprising:
a valve body having an introduction part connected to an introduction passage communicating with a fluid pressure source for introducing working fluid from an external part through the introduction passage, a plurality of supply-discharge parts connected to an object to which the working fluid is supplied and configured to supply and discharge the working fluid introduced through the introduction part, and a drain part connected to a drain passage for draining the working fluid to the external part;
a substantially circular-arc shaped filter member provided at the introduction part and having an outer periphery constructed by a frame;
a check valve arranged along an inner peripheral surface of the frame, and configured such that a part of the check valve is fixed to the inner peripheral surface of the frame, and that an outer peripheral surface of the check valve is kept in elastic-contact with the inner peripheral surface of the frame;
a spool axially movably accommodated on an inner peripheral side of the valve body, for switching a state of fluid-communication among the introduction part, the supply-discharge parts, and the drain part by axial movement of the spool;
an electromagnetic solenoid fixed to one axial end of the valve body, for attracting a movable iron core when energized and for causing the axial movement of the spool in an attraction direction; and
a biasing member for generating a biasing force in a direction opposite to the attraction direction of the movable iron core,
wherein the check valve is configured to:
permit an inflow of the working fluid through the introduction part into the valve body by flexural deformation of the check valve with movement of the check valve away from the frame, when fluid pressure is applied from an outer peripheral side of the valve body to the introduction part, and
restrict an outflow of the working fluid through the introduction part out of the valve body by bringing the outer peripheral surface of the check valve into press-contact with the inner peripheral surface of the frame, when fluid pressure is applied from the inner peripheral side of the valve body to the introduction part.
